(19) United States
(12) Patent Application Publication
(10) Pub. No.: US 2026/0054488 A1
(43) Pub. Date: Feb. 26, 2026

(54) INK SUPPLY CONTAINER

(71) Applicant: SEIKO EPSON CORPORATION, Tokyo (JP)

(72) Inventors: Shun OYA, Kiso-machi (JP); Tadahiro MIZUTANI, Shiojiri-shi (JP); Tadashi WATANABE, Matsumoto-shi (JP); Yuta KOIKE, Matsumoto-shi (JP); Atsushi KOBAYASHI, Matsumoto-shi (JP)

(73) Assignee: SEIKO EPSON CORPORATION, Tokyo (JP)

(21) Appl. No.: 19/306,566

(22) Filed: Aug. 21, 2025

(30) Foreign Application Priority Data
Aug. 22, 2024 (JP) 2024-140666
Dec. 26, 2024 (JP) 2024-229929

(51) Int. Cl. B41J 2/175

(52) U.S. Cl. CPC B41J 2/17503; B41J 2/17596

(57) ABSTRACT

An ink supply container includes an outlet valve unit. The outlet valve unit is configured to be in a valve-closed state, a sealed state in which a distal end portion of a spring seat pushed by an ink introduction member in a second direction opposite from a first direction is in contact with a front end of the ink introduction member and the membrane valve, and the membrane valve is in contact with the front end of the ink introduction member, and a valve-open state. When the ink introduction member is removed from the ink outlet forming portion, the outlet valve unit changes from the valve-open state to the sealed state and then to the valve-closed state.

The present application is based on, and claims priority from JP Application Serial Number 2024-140666, filed Aug. 22, 2024 and JP Application Serial Number 2024-229929, filed Dec. 26, 2024, the disclosures of which are hereby incorporated by reference herein in their entirety.

### BACKGROUND

### 1. Technical Field

The present disclosure relates to an ink supply container.

### 2. Related Art

A known printer, which is an example of an ink ejecting apparatus, can perform printing on a printing medium, such as printing paper, with ink by ejecting ink toward the printing medium from a recording head. Some of this type of printers are ink refillable printers, which have an ink tank to be refilled with ink. JP-A-2023-51714 discloses an ink supply container that supplies ink to a refillable ink tank.

In the known art, the ink supply container includes an ink outlet forming portion and an outlet valve unit. The ink outlet forming portion includes a valve housing, a sealing member, and a spring valve. An ink inlet channel member of the printer pushes a valve body to form a gap between the sealing member and the valve body. This gap allows ink and air to flow therethrough, and thus ink flows from the ink supply container into the ink inlet channel member. Thus, ink is supplied to the ink tank through the ink inlet channel member. In the known art, the sealing position between the ink inlet channel member and a sealing projection of the sealing member is located away from the sealing position between the valve body and a sealing end of the sealing member in the direction along the central axis and the radial direction. Thus, when the ink inlet channel member is removed from the ink outlet forming portion after ink supply, a space is formed between the valve body, the sealing member, and the ink inlet channel member. Ink might stay in this space. If the ink stays in this space, the ink may at least partially leak to the outside.

### SUMMARY

An aspect of the present disclosure provides an ink supply container configured to supply ink to an ink tank of a printer through an ink introduction member having a flow path in communication with the ink tank. This ink supply container includes a container body configured to store ink; an ink outlet forming portion connected to the container body and having an outlet on a side opposite from the container body; and an outlet valve unit mounted in the ink outlet forming portion, the outlet valve unit being configured to open when the ink introduction member is inserted through the outlet and close when the ink introduction member is removed through the outlet. The outlet valve unit includes: a valve housing; a spring member disposed in the valve housing and supported by the valve housing, the spring member configured to apply a biasing force in a first direction toward the outlet; a spring seat movably disposed in the valve housing, the spring seat configured to receive the biasing force of the spring member; and a membrane valve disposed in the valve housing and supported by the valve housing, the membrane valve having elasticity and having a hole in a center thereof. The outlet valve unit is further configured to be in a valve-closed state in which, with a distal end portion in the first direction of the spring seat being inserted into the hole of the membrane valve, a seal is formed between the distal end portion and the membrane valve, a sealed state in which the distal end portion of the spring seat pushed by the ink introduction member in a second direction opposite from the first direction is in contact with a front end of the ink introduction member and the membrane valve, and the membrane valve is in contact with the front end of the ink introduction member, and a valve-open state in which the seal between the distal end portion and the membrane valve is released by pushing the distal end portion of the spring seat in the sealed state further in the second direction, and the membrane valve is in contact with a side surface of the ink introduction member inserted into the hole and forms a seal between the membrane valve and the side surface, and when the ink introduction member is removed from the ink outlet forming portion, the outlet valve unit changes from the valve-open state to the sealed state and then to the valve-closed state.

### BRIEF DESCRIPTION OF THE DRAWINGS

FIG. 1 is a perspective view of a printer according to an embodiment.

FIG. 2 is a perspective view illustrating a state in which ink is supplied to an ink tank.

FIG. 3 is an exploded perspective view of an ink supply container.

FIG. 4 is a perspective view of an outlet valve unit.

FIG. 5 is a perspective view of a membrane valve forming member.

FIG. 6 is a front view of the ink supply container positioned in a normal orientation.

FIG. 7 is a plan view of the ink supply container.

FIG. 8 is a perspective view of the ink tank.

FIG. 9 is a partial sectional view taken along line IX-IX in FIG. 7.

FIG. 10 is a view schematically illustrating a first direction side of the ink supply container.

FIG. 11 is a view for explaining states of the outlet valve unit.

FIG. 12 is a partial sectional view of the ink supply container with a cap closed.

FIG. 13 is a partial cross-sectional view of the ink supply container with the cap completely open.

FIG. 14 is a schematic view illustrating a membrane valve forming member of Another Embodiment 1.

### DESCRIPTION OF EMBODIMENTS

### A. Embodiment

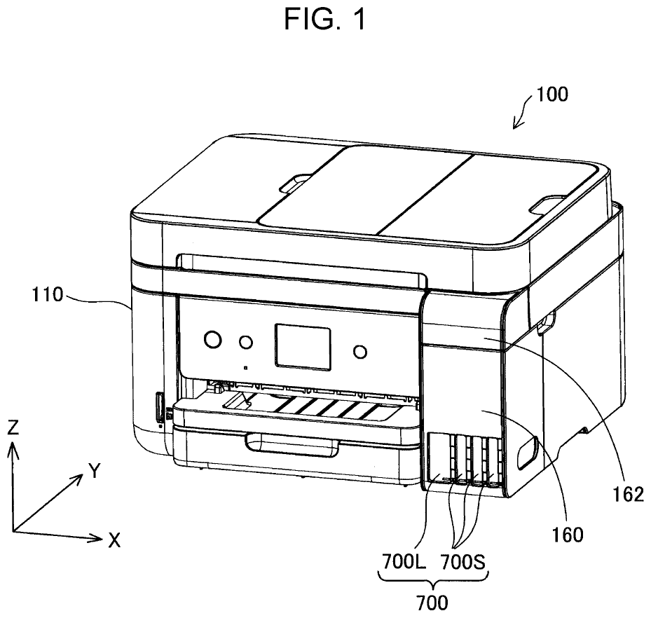

FIG. 1 is a perspective view of a printer 100 according to an embodiment. The printer 100 is an ink jet printer that performs printing by ejecting ink onto a printing medium. FIG. 1 has XYZ axes orthogonal to one another. The X axis corresponds to a width direction of the printer 100, the Y axis corresponds to a depth direction of the printer 100, and the Z axis corresponds to a height direction of the printer 100. The printer 100 is installed on a horizontal installation surface extending in the X direction and the Y direction. The “X direction” refers to a concept of a direction including the +X direction and the −X direction. Similarly, the “Y direction” refers to a concept of a direction including the +Y direction and the −Y direction, and the “Z direction” refers to a concept of a direction including the +Z direction and the −Z direction.

The printer 100 includes a housing 110. The housing 110 houses a carriage (not illustrated) movable in the X direction, which is a main scanning direction. The carriage is provided with a print head that ejects ink onto a print medium. The housing 110 has an ink tank housing unit 160, which houses ink tanks 700S and 700L, at one end of the front surface. The ink tank housing unit 160 has a cover 162, which is openable, at the upper portion. The ink tanks 700S are small-capacity tanks, and the ink tank 700L is a large-capacity tank. However, in the following description, both the ink tanks are simply referred to as “ink tanks 700” without distinction. The ink tanks 700 are each coupled to the print head of the carriage by a tube (not illustrated). That is, the ink tank 700 is a stationary ink tank that is not mounted on the carriage of the printer 100. Furthermore, each of the ink tanks 700 is a refillable ink tank in which ink is supplied from the ink supply container when the ink level becomes low. Although the ink tanks 700 are stationary ink tanks in the present embodiment, the ink tanks may be mounted on the carriage of the printer 100.

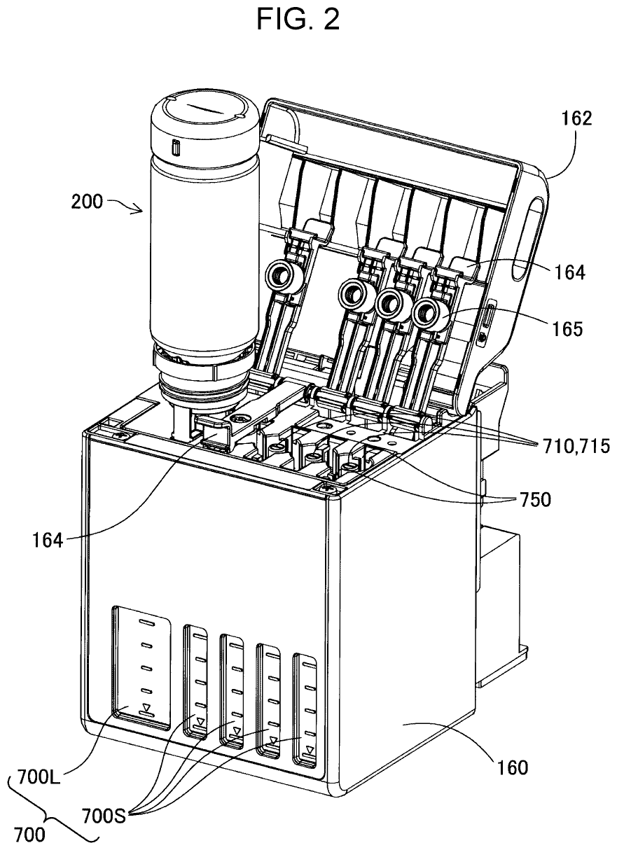

FIG. 2 is a perspective view illustrating a state in which the ink is supplied to the ink tank 700 using the ink supply container 200. A front surface of each ink tank 700 is formed of a transparent member, enabling the ink level in each ink tank 700 to be visually checked from the outside. When the ink level becomes low, as illustrated in FIG. 2, the cover 162 is opened, and ink can be supplied through an ink introduction member 710 having flow paths in communication with the ink tank 700.

Each ink tank 700 has the ink introduction member 710 having a cylindrical shape on its upper surface to supply ink to the ink tank 700. The ink tank housing unit 160 has a sealing cap member 164 having a sealing cap 165 for sealing a front end 715 of the ink introduction member 710. When the ink is not supplied to the ink tank 700, the front end 715 of the ink introduction member 710 is sealed by the sealing cap 165 of the sealing cap member 164. When the ink is supplied to the ink tank 700, the sealing cap member 164 is detached from the ink introduction member 710, and the distal end portion of the ink supply container 200 is inserted into the ink introduction member 710 to supply the ink. Two recessed portions 750 that are fitted to the fitting portions of the ink supply container 200 are provided around the ink introduction member 710. These recessed portions 750 have a 180-degree rotationally symmetric shape about the ink introduction member 710.

In the present specification, a term “ink supplying or refilling” means an action of supplying ink to the ink tanks 700 to increase the ink level. The “ink supplying or refilling” does not necessarily mean filling up the ink tank 700 with ink. In addition, the “ink supplying” also means an action of filling an empty ink tank 700 with ink when the printer 100 is used for the first time. As described above, the ink supply container 200 supplies ink to the ink tank 700 through the ink introduction member 710 having the flow paths in communication with the ink tank 700 of the printer 100.

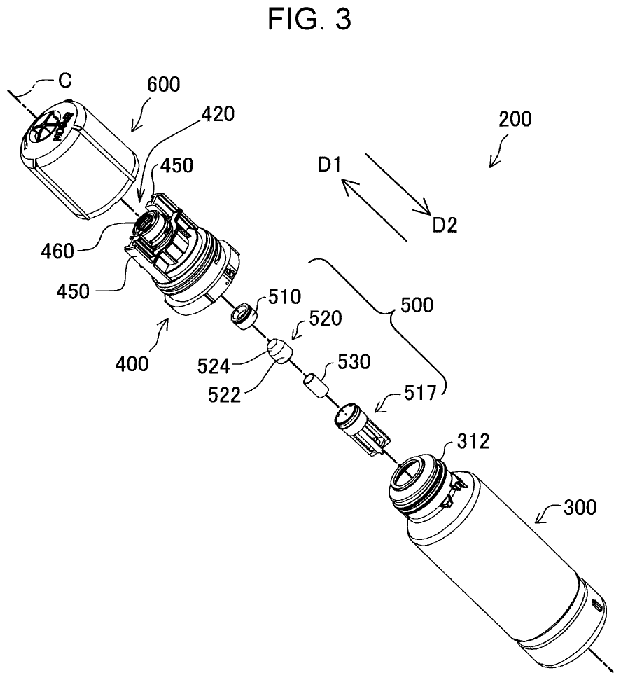

FIG. 3 is an exploded perspective view of the ink supply container 200 according to the embodiment. The ink supply container 200 includes a container body 300, an ink outlet forming portion 400, an outlet valve unit 500, and a cap 600.

The container body 300 is configured to store ink. The ink outlet forming portion 400 is connected to the container body 300. The ink outlet forming portion 400 has an outlet 460 of ink on the side opposite from the container body 300. The outlet valve unit 500 is mounted in the ink outlet forming portion 400. The outlet valve unit 500 opens when the ink introduction member 710 is inserted into the outlet 460 and closes when the ink introduction member 710 is removed from the outlet 460. The cap 600 is detachably attached to the ink outlet forming portion 400.

An upper end side of the ink supply container 200, which has the cap 600, is referred to as a “distal end side”, and a lower end side, which has the container body 300, is referred to as a “proximal end side”. The container body 300 is a hollow cylindrical container having an opening at the distal end side. A small-diameter portion at the distal end of the container body 300 has an external thread 312 for attaching the ink outlet forming portion 400. In the present disclosure, a direction parallel to the central axis C of the ink supply container 200 is referred to as an “axial direction”, and a direction perpendicular to the axial direction is referred to as a “radial direction”. Of the axial direction, a direction from the proximal end side of the container body 300 toward the outlet 460 at the distal end side is referred to as a first direction D1. A direction opposite from the first direction D1 is referred to as a second direction D2.

The ink outlet forming portion 400 has the above-described outlet 460 at the distal end. The ink outlet forming portion 400 is connected to the container body 300 and has a cylindrical portion 420 having the outlet 460. The outlet valve unit 500 is mounted in the cylindrical portion 420. Thus, the outlet valve unit 500 can be regarded as a member constituting a portion of the ink outlet forming portion 400. The outlet valve unit 500 is mounted in the cylindrical portion 420 with a radial gap between the outlet valve unit 500 and the cylindrical portion 420. To supply ink to the ink tank 700, the ink introduction member 710 of the ink tank 700 illustrated in FIG. 2 is inserted into the outlet 460.

The outlet valve unit 500 is configured to seal the outlet 460 to prevent the ink from leaking to the outside in a non-supply state in which the ink is not supplied to the ink tank 700. In addition, the outlet valve unit 500 is configured to release the seal and allow ink to flow into the ink introduction member 710 in a supply state in which the ink is supplied to the ink tank 700.

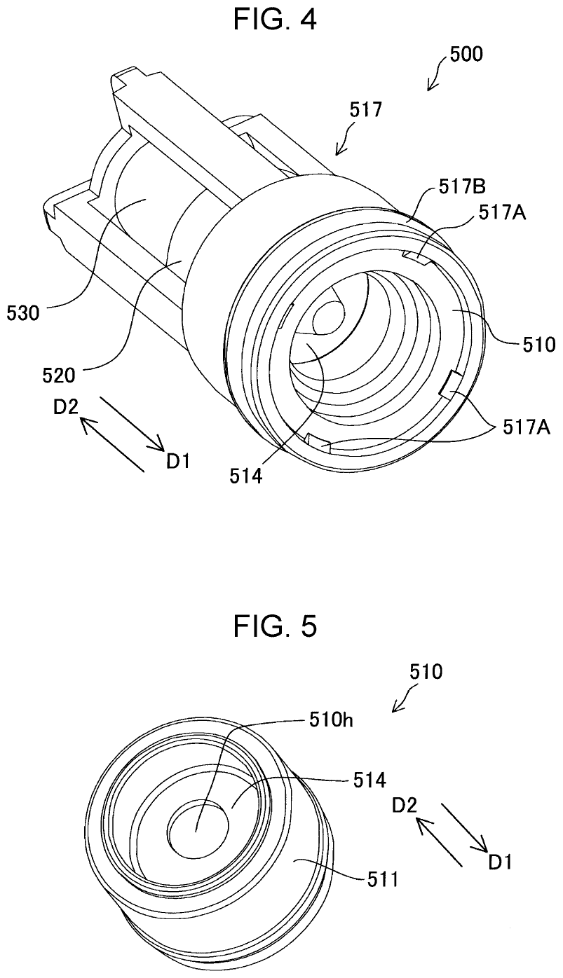

The outlet valve unit 500 has a valve housing 517, a spring member 530, a spring seat 520, and a membrane valve forming member 510 forming a membrane valve. FIG. 4 is a perspective view of the outlet valve unit 500. FIG. 5 is a perspective view of the membrane valve forming member 510. The configuration of the outlet valve unit 500 will be described with reference to FIGS. 4 and 5 in addition to FIG. 3.

The valve housing 517 illustrated in FIG. 3 allows insertion and removal of the ink introduction member 710. The valve housing 517 houses the spring member 530, the spring seat 520, and the membrane valve forming member 510. As illustrated in FIG. 4, the valve housing 517 has retaining portions 517A for preventing the membrane valve forming member 510 from coming off from the valve housing 517 and an engaging portion 517B for engaging with the cylindrical portion 420. This configuration makes the outlet valve unit 500 independently detachable as a component of the ink supply container 200, resulting in easy production.

The spring member 530 illustrated in FIG. 3 is disposed in the valve housing 517 and supported by the valve housing 517. The spring member 530 is housed in a proximal end portion of the valve housing 517 in the axial direction. The spring member 530 can be formed of, for example, metal. In the present embodiment, the spring member 530 is a coil spring. The spring member 530 biases the spring seat 520 in the first direction D1 toward the outlet 460.

The spring seat 520 is axially movable in the valve housing 517. The spring seat 520 functions as a valve body that opens and closes a flow path. The spring seat 520 is closer to the outlet 460 than the spring member 530 in the first direction D1. The spring seat 520 receives a biasing force of the spring member 530 applied in the first direction D1. The spring seat 520 has a spring placement portion 522, on which an end portion of the spring member 530 is placed, and a distal end portion 524 adjacent to the spring placement portion 522 in the first direction D1. The spring placement portion 522 has a cylindrical outer shape. The distal end portion 524 has a truncated conical outer shape. The distal end portion 524 functions as a valve body that opens and closes the flow path of the outlet valve unit 500 by coming into contact with and moving away from the membrane valve forming member 510.

The membrane valve forming member 510 illustrated in FIG. 3 is disposed in the valve housing 517 and supported by the valve housing 517. That is, the membrane valve forming member 510 is mounted in the valve housing 517. The membrane valve forming member 510 is formed of an elastic member. The membrane valve forming member 510 is formed of, for example, a rubber member, such as an elastomer having rubber elasticity.

As illustrated in FIG. 5, the membrane valve forming member 510 has a main body 511 and a membrane valve 514. The main body 511 has a substantially cylindrical shape. The main body 511 is in close contact with the inner peripheral surface of the valve housing 517. The membrane valve 514 is a membrane member that extends radially inward from the inner circumferential surface of the main body 511. The outer shape of the membrane valve 514 is circular. The membrane valve 514 has a hole 510h in the center. The diameter of the hole 510h is smaller than that of the ink introduction member 710. The membrane valve 514 is disposed in the valve housing 517 and supported by the valve housing 517. The membrane valve 514, which is a component of the membrane valve forming member 510, has elasticity. The components of the ink supply container 200 other than the spring member 530 and the membrane valve forming member 510 can be formed of a synthetic resin, such as polyethylene and polypropylene.

The outlet valve unit 500 is configured to be in any one of a valve-closed state S1 in which the outlet 460 and the container body 300 are not in communication, a sealed state S2, and a valve-open state S3 in which ink can flow from the container body 300 to the ink introduction member 710. In the valve-closed state S1, the sealed state S2, and the valve-open state S3, the spring seat 520 is in different positions in the axial direction in the valve housing 517. In the valve housing 517, the spring seat 520 is located at the foremost position in the first direction D1 of the axial direction in the valve-closed state S1 and located at the foremost position in the second direction D1 in the valve-open state S3. The valve-closed state S1, the sealed state S2, and the valve-open state S3 will also be described later with reference to the drawings.

As illustrated in FIG. 3, two fitting portions 450 are provided around the outlet 460. These fitting portions 450 are protrusions extending upward in the axial direction and are positioning members that position the ink supply container 200 by being inserted into or fitted into recesses 750 illustrated in FIG. 2, which are holes provided around the ink introduction member 710 of the ink tank 700. The positioning is, for example, at least one of a function of preventing erroneous ink injection by allowing the ink supply container 200 for supplying yellow ink to fit in the recesses 750 for the ink tank 700 storing yellow ink and not allowing the ink supply containers 200 for supplying other color inks such as magenta ink and cyan ink to fit in the recesses 750, and a function of stabilizing the ink injection posture of the ink supply container as described below. The function of preventing erroneous ink supply prevents not only erroneous supply of a different color ink but also, for example, for black ink, erroneous supply of dye black ink and pigment black ink. In the present embodiment, the two fitting portions 450 have a 180-degree rotationally symmetric shape about the central axis C of the ink supply container 200. The recesses 750 provided around the ink introduction member 710 of the ink tank 700 also have a 180-degree rotationally symmetric shape about the ink introduction member 710. At the time of ink supply, the fitting portions 450 of the ink supply container 200 are fitted in the recesses 750 around the ink introduction member 710 of the ink tank 700, limiting the orientation of the ink supply container 200 to two 180-degree rotationally symmetric orientations. Thus, the ink supply container 200 can remain in a stable orientation during ink supply. However, the fitting portions 450 are optional. The term “fit” includes a loose fit with some clearance.

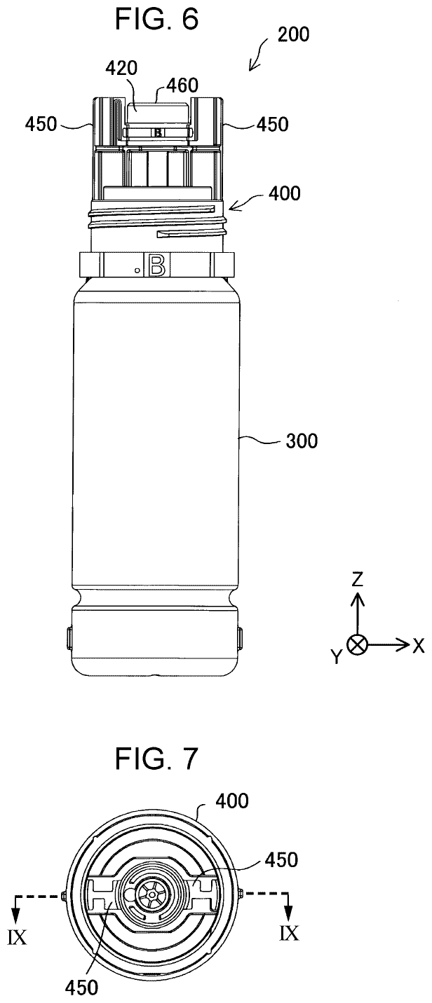

FIG. 6 is a front view of the ink supply container 200 positioned in a normal orientation, and FIG. 7 is a plan view of the ink supply container 200. The “the ink supply container 200 positioned in a normal orientation” refers to a state of the ink supply container 200 placed on a horizontal surface such as a desk with the bottom of the container body 300 down. As illustrated in FIG. 2 above, ink is supplied to the ink tank 700 in an inverted posture in which the distal end side of the ink supply container 200 faces downward. In FIGS. 6 and 7, the cap 600 is removed.

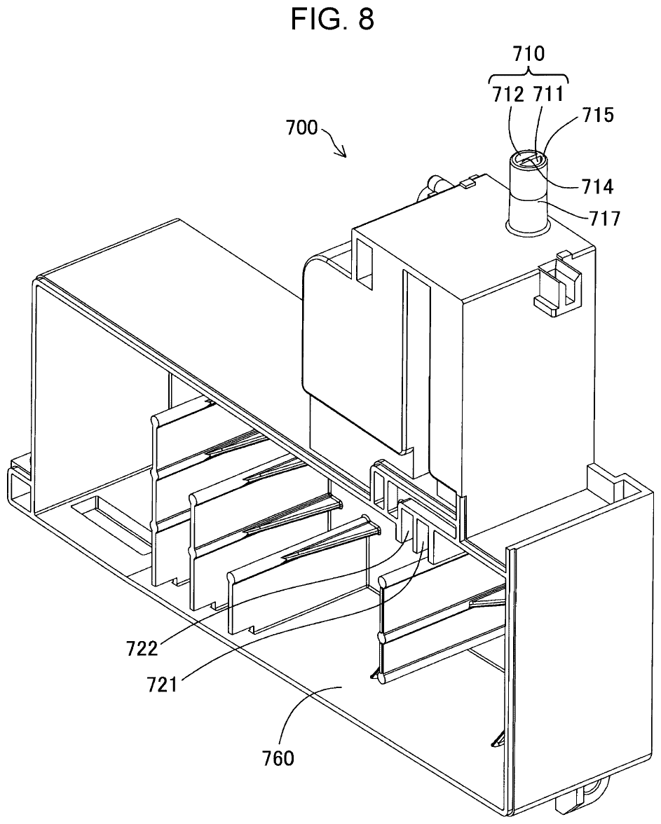

FIG. 8 is a perspective view of the ink tank 700 of the embodiment. The ink introduction member 710 of the ink tank 700 protrudes upward from the ink tank 700. The ink introduction member 710 is a hollow cylindrical member and has a side surface 717 and the front end 715.

The ink introduction member 710 has two flow paths 711 and 712. Two flow paths 711 and 712 are partitioned by a partition wall 714. At the time of ink supply, one of the flow paths 711 and 712 is a flow path for ink from the ink supply container 200, and the other is a flow path for air from the ink tank 700 to the ink supply container 200.

The front end 715 of the ink introduction member 710 is flat, and the two flow paths 711 and 712 open at the front end 715 of the ink introduction member 710. A portion of the front end 715 of the ink introduction member 710 is an end portion of the partition wall 714. At the time of ink supply, the fitting portions 450 of the ink supply container 200 illustrated in FIG. 7 are fitted in the recesses 750 around the ink introduction member 710 of the ink tank 700 illustrated in FIG. 2, and thus the ink supply container 200 is positioned in the circumferential direction. Two flow paths 711 and 712 partitioned by the partition wall 714 respectively communicate with two in-tank flow paths 721 and 722 protruding into the ink storage chamber 760 located below. The lower ends of the in-tank flow paths 721 and 722 extend down beyond the ceiling of the ink storage chamber 760. This is because, when the ink is supplied from the ink supply container 200 to the ink tank 700, the gas-liquid exchange stops when the liquid level in the ink storage chamber 760 reaches the lower ends of the in-tank flow paths 721 and 722 and the supply of the ink also stops accordingly, making the ink supply operation easy.

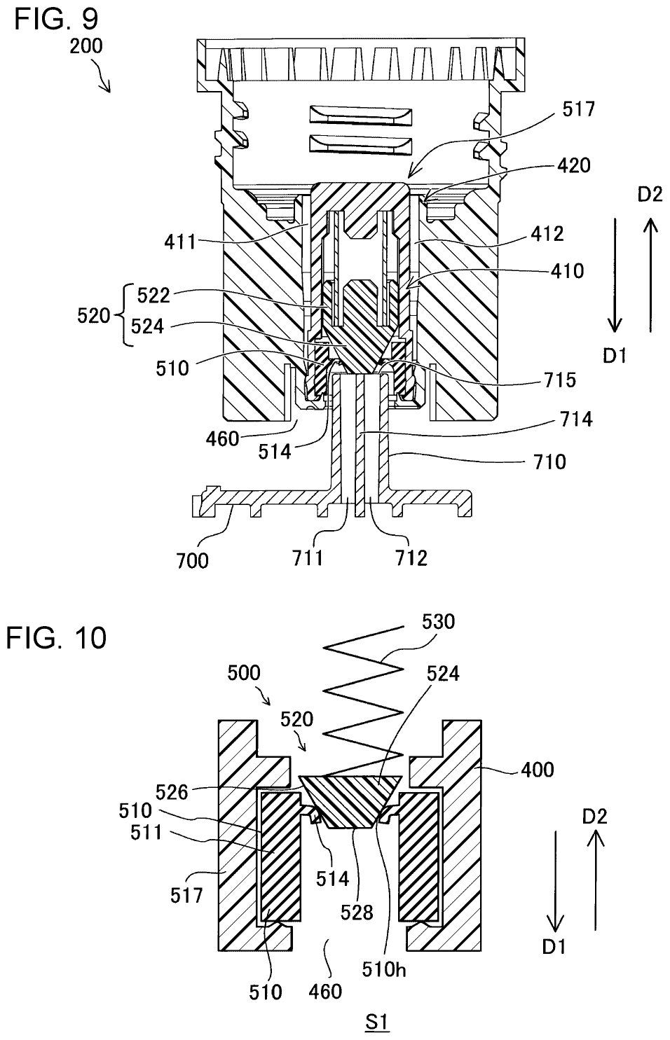

FIG. 9 is a partial sectional view taken along line IX-IX in FIG. 7. In FIG. 9, the structure of the ink tank 700 is also illustrated for ease of understanding. FIG. 9 is a view illustrating a state immediately after the ink introduction member 710 is inserted into the outlet valve unit 500 through the outlet 460 and the front end 715 of the ink introduction member 710 comes in contact with the distal end portion 524 of the spring seat 520.

When the distal end portion 524 of the spring seat 520 comes in contact with the partition wall 714 of the ink introduction member 710, the two supply flow paths 411 and 412 are formed in the gap between the valve housing 517 and the inner peripheral surface of the cylindrical portion 420. Two supply flow paths 411 and 412 allow the container body 300 and the ink introduction member 710 to communicate with each other. Furthermore, as described above, during the ink supply, one of the two supply flow paths 411 and 412 is used as an ink flow path, and the other is used as an air flow path. Thus, the ink supply container 200 can supply ink while performing gas-liquid exchange with the ink tank 700. When the ink is supplied by the gas-liquid exchange, the container body 300 does not need to be squeezed. The type of ink supply container capable of supplying ink without squeezing the container body 300 in this manner is also referred to as a “non-squeeze type”. Tubular flow path portion 410 as the flow path space inside the cylindrical portion 420 does not need to be divided into two supply flow paths 411 and 412 and may be formed as one supply flow path or three or more supply flow paths.

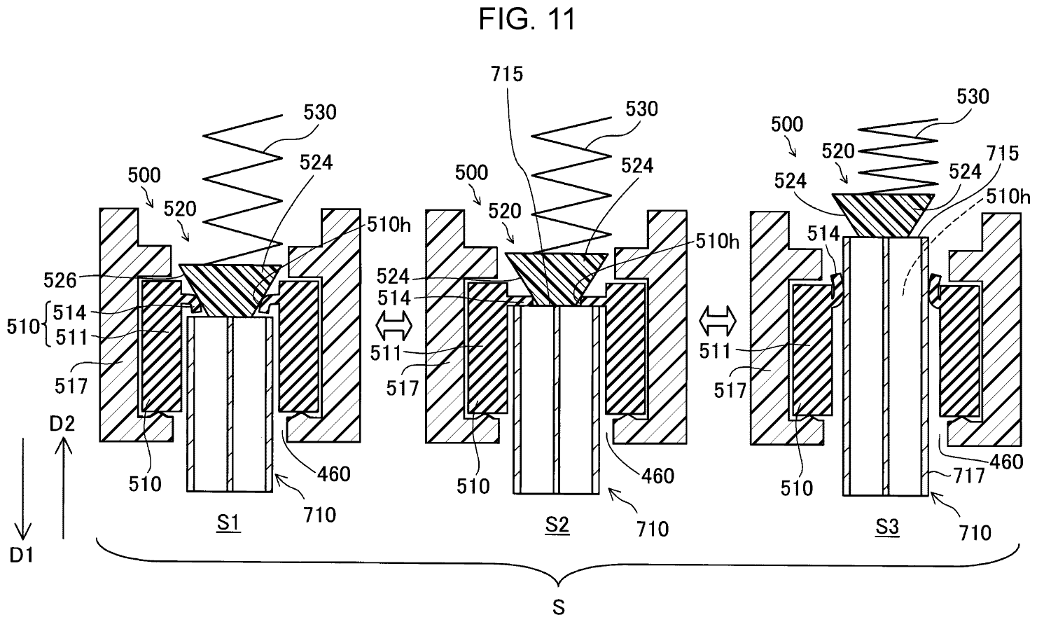

FIG. 10 is a view schematically illustrating a portion around an end in the first direction D1 of the ink supply container 200. In FIG. 10, the cap 600 illustrated in FIG. 3 is removed from the ink outlet forming portion 400. Furthermore, in FIG. 10 and FIG. 11 described later, the spring placement portion 522 of the spring seat 520 illustrated in FIG. 3 is not illustrated.

As illustrated in FIG. 10, in a bottle alone state before the ink introduction member 710 is inserted into the ink outlet forming portion 400, the outlet valve unit 500 is in the valve-closed state S1. The spring seat 520 is biased in the first direction D1 by the biasing force of the spring member 530, and thus the spring seat 520 is displaced in the first direction D1. In the valve-closed state S1, a seal is formed between the distal end portion 524 and the membrane valve 514 with the distal end portion 524 of the spring seat 520 in the first direction D1 being in the hole 510h of the membrane valve 514. That is, in the valve-closed state S1, the hole 510h of the membrane valve 514 is closed by the distal end portion 524.

The distal end portion 524 has a tapered surface 526 and a distal end surface 528. The tapered surface 526 constitutes a side surface of the distal end portion 524 having a truncated cone shape. The tapered surface 526 is a surface formed such that the cross-sectional area of the distal end portion 524 taken perpendicular to the first direction D1 increases in the second direction D2. More specifically, the tapered surface 526 is tilted with respect to the axial direction, which extends in the first direction D1, so as to be tilted radially outward as it extends in the second direction. In the valve-closed state S1, a seal is formed between the tapered surface 526 and the membrane valve 514. The distal end surface 528 is a surface of the distal end portion 524 at the end in the first direction the D1. The spring placement portion 522 illustrated in FIG. 3 is connected to an end portion in the second direction D2 of the tapered surface 526. As described above, the side surface of the distal end portion 524 is the tapered surface 526 and does not have a flat surface extending in a direction perpendicular to the first direction D1. The distal end surface 528 is a flat surface and is in contact with the partition wall 714 illustrated in FIG. 8 in the valve-closed state S1.

In the valve-closed state S1, since a seal is formed between the distal end portion 524 and the membrane valve 514 having a small thicknesses, application of a smaller force is enough to elastically deform the membrane valve 514 along the tapered surface 526 of the distal end portion 524. In other words, even when the biasing force of the spring member 530 is reduced, the seal between the membrane valve 514 and the distal end portion 524 can be maintained. This can reduce the possibility that the membrane valve 514 will be damaged, resulting in a longer service life of the membrane valve 514.

FIG. 11 is a view for explaining the state S of the outlet valve unit 500. The valve-closed state S1 in FIG. 11 shows a time point at which the ink introduction member 710 comes in contact with the distal end portion 524 without displacement of the spring seat 520.

In the valve-closed state S1 illustrated in FIG. 11, when the ink supply container 200 is pushed forward in the first direction D1, the ink introduction member 710 further moves into the outlet valve unit 500, putting the outlet valve unit 500 in the sealed state S2.

In the sealed state S2, the distal end portion 524 is pushed in the second direction D2 by the ink introduction member 710. The distal end portion 524 in the sealed state S2 is positioned farther from the outlet 460 than the distal end portion 524 in the valve-closed state S1. In the sealed state S2, the distal end portion 524 of the spring seat 520 pushed in the second direction D2 by the ink introduction member 710 is in contact with the front end 715 of the ink introduction member 710 and the membrane valve 514, and the membrane valve 514 is in contact with the front end 715 of the ink introduction member 710.

When the ink supply container 200 in the sealed state S2 is pushed further in the first direction D1, the distal end portion 524 of the spring seat 520 is pushed further in the second direction D2 from the position in the sealed state S2 by the ink introduction member 710. Thus, the spring seat 520 is further displaced in the second direction D2 in the valve housing 517 by the pushing force of the ink introduction member 710 that is larger than the biasing force of the spring member 530. This moves the distal end portion 524 away from the membrane valve 514, and the outlet valve unit 500 is in the valve-open state S3. In the process in which the ink supply container 200 is pushed further in the first direction D1 from the position in the sealed state S2, the ink introduction member 710 is inserted into the hole 510h, and the membrane valve 514 is elastically deformed such that the radially inner portion of the membrane valve 514 bends in the second direction D2. Thus, the hole 510h of the membrane valve 514 is expanded, and the membrane valve 514 and the side surface 717 of the ink introduction member 710 are in airtight contact with each other in the circumferential direction of the ink introduction member 710. This contact provides a seal between the membrane valve 514 and the side surface 717. In addition, the ink supply container 200 is pushed forward in the first direction D1 while maintaining this contact.

In the valve-open state S3, the distal end portion 524 is away from the membrane valve 514, and the seal between the distal end portion 524 and the membrane valve 514 is released. In addition, in the valve-open state S3, the membrane valve 514 is in contact with the side surface 717 of the ink introduction member 710 inserted into the hole 510h, and the gap between the membrane valve 514 and the side surface 717 is sealed.

The outlet valve unit 500 is configured, when the ink introduction member 710 is removed from the ink outlet forming portion 400, to be in the sealed state S1 after going through the valve-closed state S3 and then the valve-open state S2.

As described above, the object in the valve-closed state S1 with which the spring seat 520 is brought into contact to form a seal and the object in the valve-open state S3 with which the ink introduction member 710 is brought into contact to form a seal are the membrane valve 514 and are the same. This can reduce a space in the outlet valve unit 500 away from the distal end portion 524 in the first direction D1 in which ink may remain when the ink supply container 200 is attached to the ink introduction member 710 or the ink supply container 200 is removed from the ink introduction member 710.

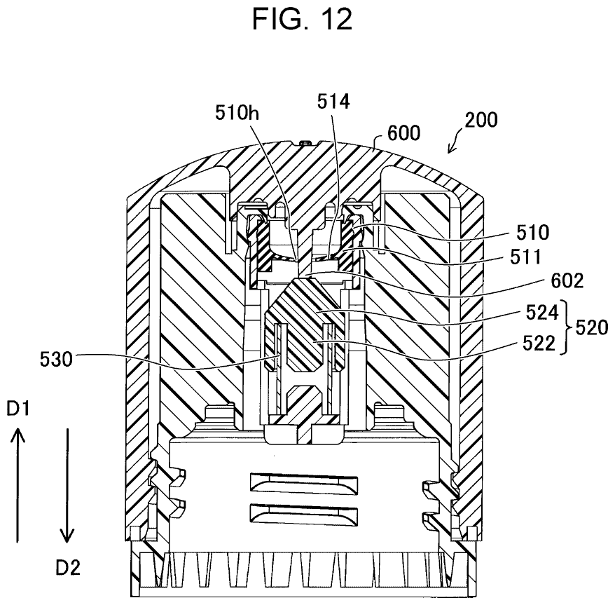

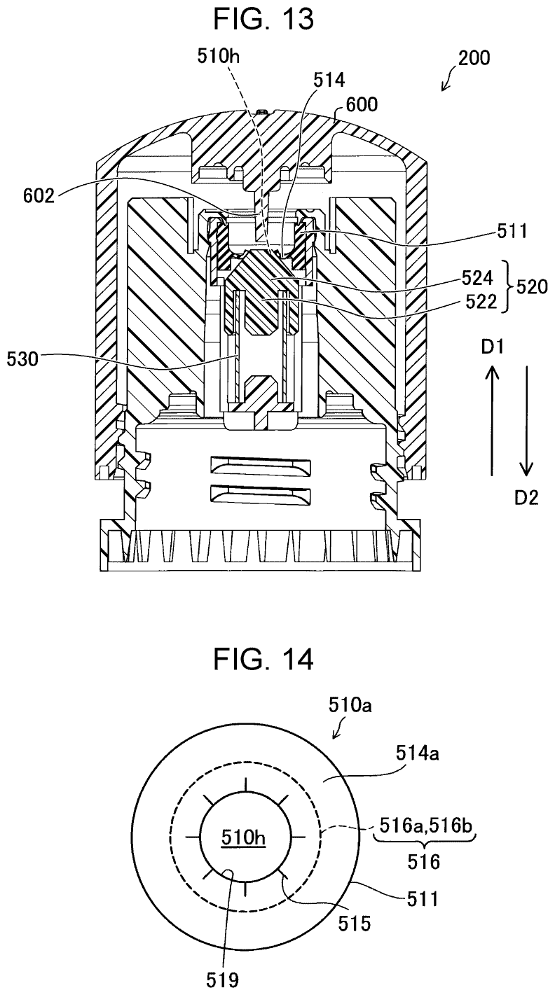

FIG. 12 is a partial cross-sectional view of the ink supply container 200 in a state where the cap 600 is closed. FIG. 13 is a partial cross-sectional view of the ink supply container 200 in a state where the cap 600 is fully open. The state where the cap 600 is closed refers to a cap attached state where the cap 600 is attached to the ink outlet forming portion 400. In the cap fully open state illustrated in FIG. 13, the valve-closed state S1 is formed in which the membrane valve 514 of the membrane valve forming member 510 and the distal end portion 524 of the spring seat 520 are in contact with each other.

As illustrated in FIG. 12, the cap 600 has a projection 602. The projection 602 is a rod-like member extending in the axial direction. In the cap attached state, the projection 602 is inserted into the hole 510h without touching the membrane valve 514. In the cap attached state, the projection 602 pushes the spring seat 520 in the second direction D2 to a position at which the distal end portion 524 of the spring seat 520 and the membrane valve 514 are away from each other.

As illustrated in FIG. 13, when the cap 600 is fully open, the outlet valve unit 500 is in the valve-closed state S1 in which the projection 602 and the distal end portion 524 of the spring seat 520 are away from each other, the membrane valve 514 and the distal end portion 524 are in contact with each other, and a seal is formed between the membrane valve 514 and the distal end portion 524.

According to the above-described embodiment, as illustrated in FIG. 11, in the sealed state S2, the distal end portion 524 of the spring seat 520, the front end 715 of the ink introduction member 710, and the membrane valve 514 are in contact with each other. Thus, the volume of a certain space, which is a space defined by the spring seat 520, the ink introduction member 710, and the membrane valve 514, can be reduced. In this embodiment, the certain space can be eliminated. This can reduce the amount of ink remaining in the certain space, reducing the possibility that the ink will leak to the outside of the ink supply container 200. For example, this can reduce that ink drips from the outlet 460 when the ink supply container 200 is removed from the ink introduction member 710. Furthermore, when the ink supply container 200 is removed from the ink introduction member 710, the gap between the membrane valve 514 and the spring seat 520 is sealed substantially at the same time the seal between the ink introduction member 710 and the membrane valve 514 is released, and thus, the leakage of the ink to the outside is further reduced.

Furthermore, according to the above-described embodiment, as illustrated in FIG. 11, in the valve-closed state S1, the hole 510h of the membrane valve 514 is closed by the spring member 530 and the spring seat 520. This can reduce the possibility that the outlet valve unit 500 will be in the valve-open state S3 in which the hole 510h of the membrane valve 514 is open even when an impact is applied, as compared with the ink supply container 200 including only the membrane valve 514.

Furthermore, according to the above-described embodiment, the membrane valve 514, which comes in contact with the ink introduction member 710 when the state is changed to the valve-open state S3, is in the form of film. This can reduce the reaction force of the membrane valve 514 compared to a case where a member that comes in contact with the ink introduction member 710 is a valve member having a thickness larger than a certain thickness. Thus, the force required when the ink supply container 200 is attached to the ink introduction member 710 decreases, enabling the user to readily attach the ink supply container 200 to the ink introduction member 710.

Furthermore, according to the above-described embodiment, in the valve-closed state S1, the membrane valve 514 having elasticity forms a seal with the distal end portion 524 of the spring seat 520. This enables, even when the distal end portion 524 is pushed against the membrane valve 514 with a smaller force, the membrane valve 514 to be in close contact with the distal end portion 524. Thus, the spring load, which is the biasing force of the spring member 530 required to push the distal end portion 524 against the membrane valve 514, can be reduced. This enables the user to more readily attach the ink supply container 200 to the ink introduction member 710.

Furthermore, according to the above-described embodiment, the membrane valve 514 is in the form of film. This reduces the resistance caused when the membrane valve 514 is deformed in a direction in which the hole 510h is widened by insertion of the ink introduction member 710 into the hole 510h compared to a valve member having a thickness larger than a certain thickness. When the ink introduction member 710 is removed from the hole 510h of the membrane valve 514, the membrane valve 514 functions as a so-called barb. This can make the resistance, which is generated when the ink introduction member 710 is removed, that is, generated when the membrane valve 514 deforms as the hole 510h returns to its original size, relatively large. Accordingly, in the valve-open state S3, when the biasing force of the spring member 530 is applied to the ink introduction member 710 via the spring seat 520, the possibility that the ink introduction member 710 will be pushed back toward the outlet 460 can be reduced. Thus, the inverted posture which is the supplying posture of the ink supply container 200 to the ink introduction member 710 can be stably maintained.

Furthermore, according to the above-described embodiment, as illustrated in FIG. 10, the spring seat 520 forms a seal between the tapered surface 526 and the membrane valve 514, resulting in less deterioration of the sealing performance even if the spring seat 520 is slightly tilted. This can reduce the possibility that the ink will leak to the outside. Furthermore, in the valve-open state S3, ink and air readily flow along the tapered surface 526. This allows smooth gas-liquid exchange between the ink supply container 200 and the ink introduction member 710, and thus the supply flow rate of the ink increases, resulting in a reduction in the ink supply time.

Furthermore, according to the above-described embodiment, as illustrated in FIG. 12, the cap 600 has the projection 602, which pushes the spring seat 520 in the second direction D2 to a position where the spring seat 520 and the membrane valve 514 are away from each other with the cap 600 being attached to the ink outlet forming portion 400. Thus, during storage of the ink supply container 200 to which the cap 600 is attached, the membrane valve 514 is less likely to be biased for a long time by the spring seat 520 and the spring member 530, reducing the possibility that the deformation is maintained even when no load is applied to the membrane valve 514. Thus, a decrease in the sealing performance between the membrane valve 514 and the spring seat 520 can be reduced. Furthermore, according to this embodiment, even if the pressure in the ink supply container 200 increases during storage of the ink supply container 200 due to environmental changes such as a temperature change and an atmospheric pressure change, a gap between the membrane valve 514 and the spring seat 520 allows the internal air to escape to the outside through the gap when the cap 600 is removed. This can reduce ink ejection due to the pressure difference between the inside and outside.

### B. Other Embodiments

### B-1. Another Embodiment 1

FIG. 14 is a schematic view illustrating a membrane valve forming member 510a of Another Embodiment 1. In FIG. 14, the membrane valve forming member 510a is viewed from the second direction D2 side. The membrane valve forming member 510 of the embodiment illustrated in FIG. 5 is different from the membrane valve forming member 510a illustrated in FIG. 14 in that a membrane valve 514a of the membrane valve forming member 510a has multiple slits 515. The other configurations of the membrane valve forming member 510a are the same as those of the first embodiment, and the same components are assigned the same reference numerals and are not described. Furthermore, the membrane valve forming member 510a of Another Embodiment 1 can be incorporated into the ink supply container 200 in place of the membrane valve forming member 510 of the above-described embodiment.

The membrane valve 514a includes a sealing portion 516 having a first sealing portion 516a that comes in contact with the spring seat 520 to form a seal with the distal end portion 524 in the valve-closed state S1 and a second sealing portion 516b that comes in contact with the side surface 717 of the ink introduction member 710 illustrated in FIG. 8 to form a seal with the side surface 717 in the valve-open state S3. Of the membrane valve 514a, the first sealing portion 516a is an annular region of one surface in the axial direction, and the second sealing portion 516b is an annular region of a surface opposite from the one surface. In Another Embodiment 1, the first sealing portion 516a and the second sealing portion 516b are at the same position in the radial direction but may be at different positions. In the above-described embodiment, although the reference numerals are omitted, the membrane valve 514 has the sealing portion 516 having the first sealing portion 516a and the second sealing portion 516b as in Another Embodiment 1.

The membrane valve 514a also has multiple slits 515. The slits 515 are arranged at regular intervals in the circumferential direction. In Another Embodiment 1, the number of slits 515 is eight. The slits 515 are each located radially inward from the sealing portion 516 and extend radially outward from an end 519 of the membrane valve 514a that defines the hole 510h. When the positions of the first sealing portion 516a and the second sealing portion 516b in the radial direction are different, “radially inward from the sealing portion 516” means radially inward from a frame region formed by connecting the most radially inner parts of the sealing portion 516 at the circumferential positions.

According to Another Embodiment 1, the following advantages are further achieved in addition to the advantages of the above-described embodiment. The resistance caused when the ink introduction member 710 is inserted into the hole 510h of the membrane valve 514a is smaller than that in a configuration without the slits 515, and thus the user can more readily attach the ink supply container 200 to the ink introduction member 710.

### B-2. Another Embodiment 2

As illustrated in FIG. 10, in the above-described embodiment, the distal end portion 524 has the tapered surface 526, but the tapered surface 526 is optional. For example, instead of the tapered surface 526, the distal end portion 524 may include a first columnar portion having a first outer diameter and a second columnar portion located adjacent to the first columnar portion in the first direction D1 and having a second outer diameter smaller than the first outer diameter.

### C. Other Forms

The present disclosure is not limited to the above-described embodiments, and can be realized in various forms without departing from the gist of the disclosure. For example, the present disclosure can also be implemented in the following forms. Technical features in the above embodiments corresponding to technical features in respective forms described below can be replaced or combined as appropriate to solve some or all of the problems of the present disclosure, or achieve some or all of the advantages of the present disclosure. If the technical features are not described as essential in this specification, the technical features can be omitted as appropriate.

(1) An aspect of the present disclosure provides an ink supply container configured to supply ink to an ink tank of a printer through an ink introduction member having a flow path in communication with the ink tank. This ink supply container includes a container body configured to store ink; an ink outlet forming portion connected to the container body and having an outlet on a side opposite from the container body; and an outlet valve unit mounted in the ink outlet forming portion, the outlet valve unit being configured to be opened by the ink introduction member inserted through the outlet and to be closed by removal of the ink introduction member through the outlet. The outlet valve unit includes: a valve housing; a spring member disposed in the valve housing and supported by the valve housing, the spring member configured to apply a biasing force in a first direction toward the outlet; a spring seat movably disposed in the valve housing and configured to receive the biasing force of the spring member; and a membrane valve disposed in the valve housing and supported by the valve housing, the membrane valve having elasticity and having a hole in a center thereof. The outlet valve unit is further configured to be in a valve-closed state in which, with a distal end portion in the first direction of the spring seat being inserted into the hole of the membrane valve, a seal is formed between the distal end portion and the membrane valve, a sealed state in which the distal end portion of the spring seat pushed by the ink introduction member in a second direction opposite from the first direction is in contact with a front end of the ink introduction member and the membrane valve, and the membrane valve is in contact with the front end of the ink introduction member, and a valve-open state in which the seal between the distal end portion and the membrane valve is released by pushing the distal end portion of the spring seat in the sealed state further in the second direction, and the membrane valve is in contact with a side surface of the ink introduction member inserted into the hole and forms a seal between the membrane valve and the side surface, and when the ink introduction member is removed from the ink outlet forming portion, the outlet valve unit changes from the valve-open state to the sealed state and then to the valve-closed state.

According to this aspect, in the sealed state, the distal end portion of the spring seat, the distal end of the ink introduction member, and the membrane valve are in contact with each other. Thus, the volume of the space defined by the spring seat, the ink introduction member, and the membrane valve, can be reduced. This can reduce the amount of ink remaining in this space, reducing the possibility that the ink will leak to the outside of the ink supply container.

(2) In the above aspect, the distal end portion of the spring seat may have a tapered surface that increases a cross-sectional area of the distal end portion taken in a direction perpendicular to the first direction as the tapered surface extends in the second direction, and the tapered surface may form a seal with the membrane valve in the closed-valve state. According to this aspect, the spring seat forms a seal between the tapered surface and the membrane valve, resulting in less deterioration of the sealing performance even if the spring seat is slightly tilted. This can reduce the possibility that the ink will leak to the outside. Furthermore, in the valve-open state, ink and air readily flow along the tapered surface. This allows smooth gas-liquid exchange between the ink supply container and the ink introduction member, resulting in a reduction in the ink supply time.

(3) In the above-described aspect, the membrane valve may include: a sealing portion having a first sealing portion configured to be in contact with the spring seat and form a seal with the distal end portion in the valve-closed state and a second sealing portion configured to be in contact with the side surface and form a seal with the side surface in the valve-open state; and at least one slit located radially inward from the sealing portion and extending radially outward from an end of the membrane valve that defines the hole. According to this aspect, the resistance caused when the ink introduction member is inserted into the hole of the membrane valve is smaller than that in a configuration without the slits, and thus the user can more readily attach the ink supply container to the ink introduction member.

(4) The above-described aspect may further include a cap detachably attached to the ink outlet forming portion. The cap may include a protrusion configured to push the spring seat in the second direction to a position where the spring seat and the membrane valve are away from each other with the cap being attached to the ink outlet forming portion. According to this aspect, during storage of the ink supply container to which the cap is attached, the membrane valve is less likely to be biased for a long time by the spring seat and the spring member, reducing the possibility that the deformation is maintained even when no load is applied to the membrane valve. Thus, a decrease in the sealing performance between the membrane valve and the spring seat can be reduced. Furthermore, according to this aspect, even if the pressure in the ink supply container increases during storage of the ink supply container due to environmental changes such as a temperature change and an atmospheric pressure change, a gap between the membrane valve and the spring seat allows the internal air to escape to the outside through the gap when the cap is removed. This can reduce ink ejection due to the pressure difference between the inside and outside.

The present disclosure can be implemented in various forms other than the above. For example, the present disclosure can be implemented in the form of a method for producing an ink supply container.

What is claimed is:

1. An ink supply container configured to supply ink to an ink tank of a printer through an ink introduction member having a flow path in communication with the ink tank, the ink supply container comprising:
a container body configured to store ink;
an ink outlet forming portion connected to the container body and having an outlet on a side opposite from the container body; and
an outlet valve unit mounted in the ink outlet forming portion, the outlet valve unit being configured to be opened by the ink introduction member inserted through the outlet and to be closed by removal of the ink introduction member through the outlet;
the outlet valve unit includes:
a valve housing;
a spring member disposed in the valve housing and supported by the valve housing, the spring member configured to apply a biasing force in a first direction toward the outlet;
a spring seat movably disposed in the valve housing and configured to receive the biasing force of the spring member; and
a membrane valve disposed in the valve housing and supported by the valve housing, the membrane valve having elasticity and having a hole in a center thereof, wherein
the outlet valve unit is further configured to be in a valve-closed state in which, with a distal end portion in the first direction of the spring seat being inserted into the hole of the membrane valve, a seal is formed between the distal end portion and the membrane valve,
a sealed state in which the distal end portion of the spring seat pushed by the ink introduction member in a second direction opposite from the first direction is in contact with a front end of the ink introduction member and the membrane valve, and the membrane valve is in contact with the front end of the ink introduction member, and
a valve-open state in which the seal between the distal end portion and the membrane valve is released by pushing the distal end portion of the spring seat in the sealed state further in the second direction, and the membrane valve is in contact with a side surface of the ink introduction member inserted into the hole and forms a seal between the membrane valve and the side surface, and
when the ink introduction member is removed from the ink outlet forming portion, the outlet valve unit changes from the valve-open state to the sealed state and then to the valve-closed state.

2. The ink supply container according to claim 1, wherein
the distal end portion of the spring seat has a tapered surface that increases a cross-sectional area of the distal end portion taken in a direction perpendicular to the first direction as the tapered surface extends in the second direction, and the tapered surface forms a seal with the membrane valve in the valve-closed state.

3. The ink supply container according to claim 1, wherein
the membrane valve includes: a sealing portion having a first sealing portion configured to be in contact with the spring seat and form a seal with the distal end portion in the valve-closed state and a second sealing portion configured to be in contact with the side surface and form a seal with the side surface in the valve-open state; and at least one slit located radially inward from the sealing portion and extending radially outward from an end of the membrane valve that defines the hole.

4. The ink supply container according to claim 1, further comprising
a cap detachably attached to the ink outlet forming portion, wherein
the cap includes a protrusion configured to push the spring seat in the second direction to a position where the spring seat and the membrane valve are away from each other with the cap being attached to the ink outlet forming portion.
